(19) United States
(12) Patent Application Publication
(10) Pub. No.: US 2005/0216106 A1
(43) Pub. Date: Sep. 29, 2005

(54) Sensor-machine interface and method for operating the same

(75) Inventor: Bernd Maenner, Bahlingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SICK AG, Waldkirch (DE)

(21) Appl. No.: 10/508,167

(22) PCT Filed: Mar. 8, 2003
(86) PCT No.: PCT/EP03/02386

§ 371 Date: Sep. 17, 2004

(30) Foreign Application Priority Data
Mar. 18, 2002 (DE) 102 11 941.4
Mar. 18, 2002 (DE) 102 13 754.4

(51) Int. Cl. G05B 9/02; G05B 19/42

(52) U.S. Cl. 700/79; 700/87

(57) ABSTRACT

The invention relates to a sensor-machine interface (1) for coupling at least one sensor (9) to at least one machine (10). Said interface comprises at least one sensor input (5) for receiving signals relating to the condition of the sensor, at least one machine output (8) for emitting signals that control the machine, a program memory (4), in addition to a control unit (3) for impinging the machine output in a program-controlled manner in accordance with the signals received via the sensor input. The invention also relates to a method for operating an interface of this type.

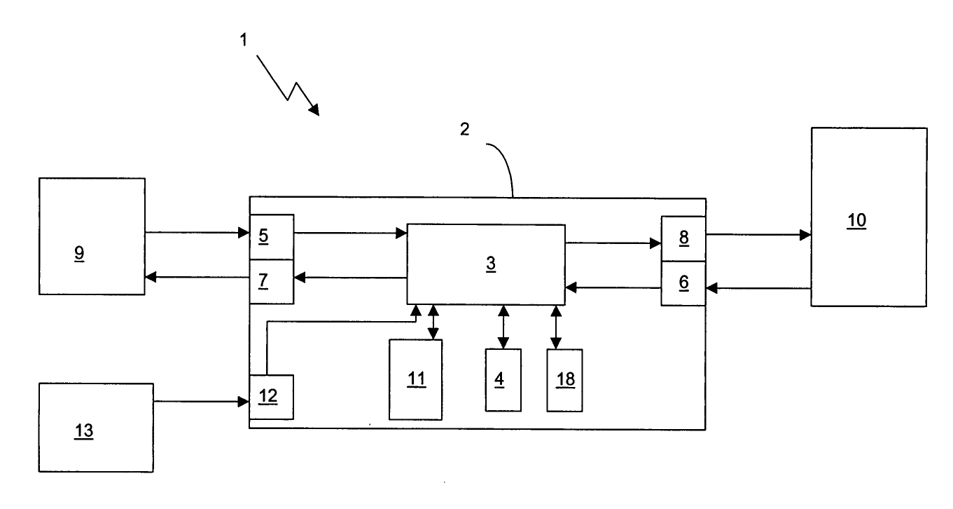

The invention relates to a sensor/machine interface for the coupling of at least one sensor to at least one machine.

In accordance with the prior art, sensors such as light grids, light barriers or scanners are directly connected to a machine, for example to a press, to a robot, to an engine, etc. or to the control computer associated with the machine.

Such a connection is disadvantageous when safety standards have to be observed with respect to the total sensor/machine arrangement in order to avoid injuries to operators, for example. In this case, the safety-relevant job of evaluating signals coming from the sensor and of transforming them into control signals or switch-off signals for the machine namely falls to the control computer associated with the machine. Accordingly, the whole control computer, which is relatively complex as a rule, must satisfy the respectively required safety standards, although only a few of the jobs it has to do are relevant to safety. Accordingly, even though it largely takes over jobs not relevant to safety, the complete control computer must therefore be designed such that it, and equally the software running on the control computer, satisfies the respectively applicable safety standards, which is associated with a disadvantageously high economic effort. The satisfaction of the safety standards must in particular be inspected for every machine or for every control computer, including the associated software, by a correspondingly responsible licensing office, which additionally increases the effort to be made.

An object underlying the invention consists of designing a sensor/machine coupling of the said kind such that it can be realized at favorable cost and such that it in particular simultaneously satisfies the respectively applicable safety standard.

In accordance with the invention, this object is satisfied by a sensor/machine interface for the coupling of at least one sensor to at least one machine having at least one sensor input for the reception of sensor state signals, at least one machine out-put for the transmission of machine control signals, a program memory and a control unit for outputting program control signals to the machine output in dependence on the signals received via the sensor input.

In accordance with the invention, the safety-relevant part of the control computer belonging to a machine is therefore taken out of the control computer and transposed into a sensor/machine interface. This is a separate, comparatively small assembly which is interposed between the sensor and the machine or between the sensor and the control computer of the machine. This assembly takes over the job of converting the signals coming from the sensor into control signals or switch-off signals for the machine. This advantageously has the effect that only the sensor/machine interface which is provided in accordance with the invention and which is substantially less complex in comparison with the machine control computer has to satisfy the respectively applicable safety standards, whereas the control computer can thus be designed at a favorable cost in a conventional manner. In addition, the sensor/machine interface in accordance with the invention can be made such that it is suitable for connection to a plurality of different machines and to a plurality of different sensors such that in each case only one and the same sensor/machine interface with the associated software has to be licensed with respect to the satisfaction of the applicable safety standards for a corresponding plurality of different combinations of sensors and machines. This brings about a further cost advantage.

The sensor/machine interface in accordance with the invention, which is preferably accommodated in a housing separate from the sensor and from the machine, can additionally advantageously have at least one machine input for the reception of machine state signals, with it being possible to control the machine output by the signals received via the sensor input and/or via the machine input. It accordingly becomes possible by the said machine input to control a machine not only in dependence on sensor signals, but simultaneously also in dependence on machine states.

In a generalized form, the interface in accordance with the invention is therefore preferably operated such that, on the reception of specific sensor signals or machine state signals or of specific combinations of sensor signals and machine state signals, no machine switch-off signal is transmitted and, on the reception of other sensor signals or machine state signals via the machine output, a machine switch-off signal is transmitted.

It is furthermore of advantage for the machine output to be designed for the transmission of machine switch-off signals and/or for the transmission of machine actuation signals, in particular machine clock signals.

The hardware and software of the sensor/machine interface in accordance with the invention preferably satisfy customary safety standards, in particular the standards IEC61508 and/or EN61496. To ensure these safety standards, at least the control unit present in the interface can be present in duplicate in a redundant manner.

Different programs or program modules can be stored in the program memory so that the program control of the machine output can be carried out in different manners. The sensor/machine interface in accordance with the invention can be matched to different operating demands, to different sensors and to different machines by this measure. The different programs or program modules can be loaded into the program memory by an external programming device, in particular by a computer or by a laptop, via a programming interface. It is in particular possible to assemble the programs stored in the program memory from pre-determined program modules via an operating interface in particular running on the computer or on the laptop. The assembly of the programs from individual program modules has the advantage that only the individual program modules have to be inspected or licensed with respect to the satisfaction of safety demands, whereby it is then ensured that the programs assembled from these program modules also satisfy the corresponding safety standards. A separate licensing of the finished programs is then no longer necessary so that—by the licensing of a limited number of program modules—a very much higher number of programs assembled from these modules is available without these programs having to be separately licensed.

The sensor/machine interface in accordance with the invention can be provided with a plurality of sensor inputs, sensor outputs, machine outputs and/or machine inputs in order thus to permit the simultaneous operation of a plurality of sensors and/or machines in connection with a single sensor/machine interface.

Further preferred embodiments of the interface in accordance with the invention and of methods for its operation are recited in the dependent claims.

The invention will be described in the following with reference to an embodiment and to the only drawing. This drawing shows a block diagram of a sensor/machine interface with devices or machines connected thereto.

The sensor/machine interface 1 in accordance with the invention is accommodated in a housing 2. It has a control unit 3 which communicates with a program memory 4.

The control unit 3 is furthermore in a position to receive signals which are made available from a sensor input 5 and from a machine input 6. The control unit 3 can furthermore control a sensor output 7 and a machine output 8.

The sensor/machine interface 1 is connected to a sensor 9, for example to a light grid, via the sensor input 5 and the sensor output 7. The sensor/machine interface 1 is connected to a processing machine 10, for example to a press, in a corresponding manner via the machine input 6 and via the machine output 8.

A program module memory 11 is furthermore present in the housing 2 and a plurality of program modules forming a program library are stored therein. The program module memory 11 communicates like the program memory 4 with the control unit 3.

The sensor/machine interface 1 is furthermore provided with a programming interface 12 to which a laptop 13 can be connected. The laptop 13 can communicate with the control unit 3 via this programming interface 12.

The putting into operation of an arrangement in accordance with the described block diagram can take place as follows, for example:

A laptop 13 is connected to the programming interface 12. Different program modules are then loaded from the program module memory 11 via the operating interface running on the laptop 13 and are assembled to one or more programs which are matched to the respective application and which are then stored in the program memory 4.

The unit of sensor/machine interface 1, sensor 9 and machine 10 can subsequently enter into operation. The respective program running in the control unit 3 can control the machine 10 in the desired manner via the machine output 8 in dependence on sensor state signals which are supplied via the sensor input 5 and on machine state signals which are supplied via the machine input 6.

1. A sensor/machine interface (1) for the coupling of at least one sensor (9) to at least one machine (10) having at least one sensor input (5) for the reception of sensor state signals, at least one machine output (8) for the transmission of machine control signals, a program memory (4) and a control unit (3) for outputting program control signals to the machine output (8) in dependence on the signals received via the sensor input (5).

2. A sensor/machine interface in accordance with claim 1, characterized in that the sensor/machine interface (1) is accommodated in a housing (2) separate from the sensor (9) and from the machine (10).

3. A sensor/machine interface in accordance with claim 1, characterized in that at least one machine input (6) is provided for the reception of machine state signals (8), with it being possible to control the machine output in dependence on signals received via the sensor input (5) and/or via the machine input (6).

4. A sensor/machine interface in accordance with claim 1, characterized in that the machine output (8) is designed for the transmission of machine switch-off signals and/or for the transmission of machine actuation signals, in particular machine clock signals.

5. A sensor/machine interface in accordance with claim 1, characterized in that the hardware and the software satisfy customary safety standards, in particular the standards IEC61508 and/or EN 61496.

6. A sensor/machine interface in accordance with claim 1, characterized in that at least the control unit (3) is present in duplicate in a redundant manner.

7. A sensor/machine interface in accordance with claim 1, characterized in that different programs or program modules can be stored in the program memory (4) so that the program control of the machine output (8) can be carried out in different manners.

8. A sensor/machine interface in accordance with claim 7, characterized in that the different programs or program modules can be loaded into the program memory (4) by an external programming device (13), in particular by a computer or by a laptop, via a programming interface (12).

9. A sensor/machine interface in accordance with claim 7, characterized in that a plurality of program modules forming a program library can be assembled into programs.

10. A sensor/machine interface in accordance with claim 7, characterized in that the program modules, and thus also the programs assembled from them, satisfy customary safety standards, in particular the standards IEC61508 and/or EN 61496.

11. A sensor/machine interface in accordance with claim 1, characterized in that a plurality of sensor inputs (5), sensor outputs (7), machine outputs (8) and/or machine inputs (6) are provided.
